(19) United States
(12) Patent Application Publication
(10) Pub. No.: US 2023/0322351 A1
(43) Pub. Date: Oct. 12, 2023

(54) ENERGY SUPPLY SYSTEM FOR A WATERCRAFT

(71) Applicant: SKF MARINE GMBH, Hamburg (DE)

(72) Inventors: Joerg GRABBEL, Hamburg (DE); Sascha KORTEMEIER, Hamburg (DE)

(21) Appl. No.: 18/025,080

(22) PCT Filed: Sep. 13, 2021
(86) PCT No.: PCT/EP2021/075070

§ 371 Date: Mar. 7, 2023

(30) Foreign Application Priority Data
Sep. 14, 2020 (DE) 10 2020 211 493.5

(51) Int. Cl. B63H 25/24; B63J 3/04; H02J 1/08; B60L 1/00

(52) U.S. Cl. CPC B63H 25/24; B63J 3/04; H02J 1/08; B63J 2003/002; B60L 2200/32; B60L 2210/40; B60L 1/003

(57) ABSTRACT

The invention relates to an energy supply system for a watercraft with a main energy converter that is configured for connection to an electrical system of the watercraft. According to invention, the main energy converter is connected to a DC busbar, and at least one inverter is connected to the DC busbar for supplying a consumer respectively associated with this inverter, and at least one electrical energy storage is connected to the DC busbar. Due to the common use of electrical components, among other things, a significant reduction of the installation space requirements of the energy supply system 100 is realizable for a watercraft.

The invention relates to an energy supply system for a watercraft, with a main energy converter that is configured for connection to an electrical system of the watercraft.

With classical frequency converters (so-called compact converters or block converters) in a power train for a fin stabilizer or a steering gear of a ship, only the use of a comparatively small external electrical storage is provided on the DC intermediate circuit of the frequency converter. Large storage can only be connected to the input side of the AC electrical system of a ship, which, however, requires an extremely complex regulation. Furthermore, the use of a compact converter or block converter in DC electrical systems of ships is only possible with restrictions and special requirements on the electrical system.

An object of the invention is to provide a space-saving energy supply system for electrical consumers of a watercraft that cause high peak loads.

The above-mentioned object is achieved by the main energy converter being connected to the DC busbar of at least one inverter for the supplying of a consumer respectively associated therewith, and at least one electrical energy storage being connected to the DC busbar. An overloading of the electrical system by load peaks is thereby avoided, which can occur, for example, with the operation of large consumers that cause high load peaks such as stabilizing devices, steering gears of steering systems, etc. Due to the common component use within the energy supply system, installation space and costs can be saved. The spatially resolved design of the energy supply system furthermore makes it possible to use a central power feed from the electrical system of the watercraft and a common electrical storage system. This circumstance reduces space problems frequently present on yachts and smaller ships. The regulating of an electrical load flow control required for operation is likewise simplified. The resolved or modular design also makes possible the use of a so-called active front end module (AFE) in the case of an electrical system operated with three-phase current, or the use of a DC/DC converter of a DC voltage converter in the case of a direct-current or DC electrical system, whereby in both cases the electrical power consumption from the electrical system can be limited, and the electrical system is protected from high short-term peak loads. As a result, the peak load to be stipulated for the ship generator can be reduced. All advantages of converters, such as softstarter functionality, recuperation ability, and speed control remain preserved.

The at least one consumer is preferably a consumer causing high peak loads, such as a stabilizing device or a steering system of the watercraft. An overload of the electrical system is thereby avoided that could otherwise occur with direct connection of such consumers to the electrical system.

In the case of one design the electrical system of the ship is a three-phase supply. The inventive energy supply system is thereby usable in standard electrical system types finding use worldwide in the form of a three-phase power supply system in the versions IT system, TN system, and TT system.

The main energy converter preferably includes at least one rectifier. As a result, it is possible to connect and feed the DC busbar from an onboard network of a watercraft operated with three-phase current.

In another technically favorable design, the main energy converter includes at least one active front end module. A reduction of the energy flow is thereby possible.

In the case of another advantageous design, the electrical system of the ship is a direct current network. As a result, the energy supply system can be used on smaller ships or yachts without a three-phase power system.

According to one technically advantageous further development, the main energy converter includes at least one DC-DC converter. A connecting of the energy supply system to a DC electrical system of a watercraft is thereby possible.

The energy storage preferably includes at least one energy converter for connecting to the DC busbar and at least one storage unit. Available but not currently needed electrical energy can thereby be temporarily stored by charging the storage unit, and an increased current consumption by consumers that could otherwise lead to an overloading of the electrical system can be compensated for by discharging the storage unit.

In the following, a preferred exemplary embodiment of the invention is explained in more detail based on the FIGURE.

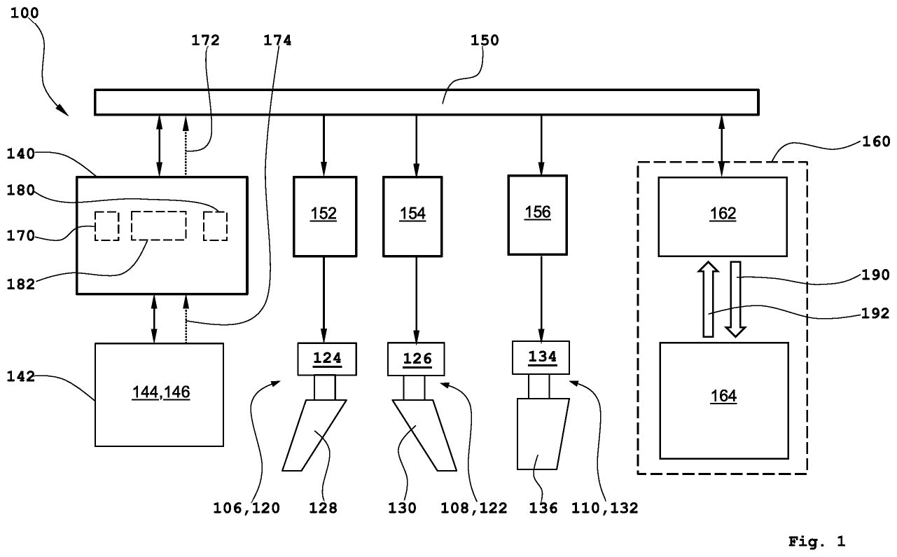

FIG. 1 shows a schematic block circuit diagram of an inventive energy supply system.

FIG. 1 shows a schematic block circuit diagram of an inventive energy supply system. Merely by way of example, an energy supply system 100 is used here for the supplying of three electrical consumers 106, 108, 110, causing high electrical peak loads, of a watercraft, not graphically depicted, such as a ship, a pontoon, a platform, or the like. The electrical consumers 106, 108, 110 are each embodied here, merely by way of example, as a stabilizing device 120, 122, or as so-called fin stabilizers, each with an associated electrical drive unit 124, 126, for the swiveling driving of a respectively associated stabilizing fin 128, 130. The further electrical consumer 110 is embodied here, merely by way of example, as a steering system 132 with an associated electrical drive unit 134 or a steering gear for the swiveling driving of a rudder blade 136. In a known manner, the stabilizing fins 128, 130 serve to stabilize the watercraft about at least one spatial axis, while the rudder blade 136 is provided for influencing the course of the watercraft. At least stabilization about a roll axis of a hull of the watercraft is preferably effected. The electrical drive units 124, 126, 134 of the electrical consumers 106, 108, 110, can be, for example, electromechanical drives or electrohydraulic drives that usually require a three-phase or alternating current connection. In addition, if needed, further consumers causing high electrical shock loads, such as, for example, thrusters, pumps, electrical drives, etc. can be connected to the energy supply system 100.

The energy supply system 100 comprises, inter alia, a main energy converter 140 that is configured for connection to an electrical system 142 of the watercraft equipped with the inventive energy supply system 100. The main energy converter 140 is electrically connected to a central DC busbar 150 or a DC bus (DC intermediate circuit). Here only by way of example, three inverters 152, 154, 156, or so-called DC-AC converters are connected to the DC busbar for the supplying of the electrical consumers 106, 108, 110. With the help of the inverters 152, 154, 156, the transformation is effected of the direct current provided by the DC busbar into three-phase current that is usually required for the operation of three-phase alternating current motors, which are frequently installed in the electrical drive units 124, 126 of the stabilizing devices 120, 122, and the electrical drive unit 134 of the steering system 132.

In addition, an energy storage 160 is connected to the DC busbar 150. For this purpose, an energy converter 162 is integrated in the energy storage 160. The energy converter 162 represents the bidirectional electrical interface between the DC busbar 150 and the energy storage 160.

A direction of the respective electrical energy flows between the electrical system 142 and the main energy converter 140, between the main energy converter 140 and the DC busbar 150, between the DC busbar 150 and the inverters 152, 154, 156, as well as between the DC busbar 150 and the energy converter 162 of the energy storage 160, are each symbolized here with the aid of black arrows and double arrows, which for the sake of better graphical clarity are not provided with reference numbers. The same applies for the electrical energy flows between the inverters 152, 154, 156 and the electrical consumers 106, 108, 110 connected downstream from them in the form of the electrical drive units 124, 126 of the stabilizing devices 120, 122, and the drive unit 134 of the steering system 132. Here a simple black arrow defines a unidirectional flow of electrical energy between two of the respective above-mentioned components, while a double arrow stands for a bidirectional flow or exchange of electrical energy between two respective components.

A universal storage unit 164 integrated in the energy storage 160 is configured for the temporary storage of different energy forms, such as electrical energy, kinetic energy, chemical energy, or thermal energy. The storage unit 160 is preferably provided for the low-loss storage of electrical energy since the energy converter 162 can be most easily realized in terms of circuit technology in such a configuration.

The storage unit 164, not depicted in detail, can be configured, for example, with a plurality of high-capacitance (single) capacitors, which, when electrically interconnected with one another, form an efficient and compact capacitor battery with high voltage and large capacity. In such a configuration, the energy converter 162 includes at least one DC-DC converter or a DC voltage converter for electrically adapting the capacitor battery to the DC busbar 150.

Alternatively or additionally, the storage unit 164 can include at least one centrifugal mass system, such as, for example, at least one flywheel rotating at very high rotational speed up to 100,000 revolutions per minute. In addition, the storage unit 164 can comprise chemical batteries with a high energy density, such as, for example, lithium batteries, or lithium polymer batteries, for the storing of excess electrical energy in the region of the DC voltage busbar 150. A large, stationary redox flow cell can also optionally be used as a battery. Furthermore, the energy storage 160 can include at least one electrolysis cell and at least one fuel cell. With the aid of the electrolysis cell, excess DC current in the region of the DC busbar 150 can be transformed into gaseous hydrogen, which is correspondingly permanently storable compressed in pressure tanks. Alternatively metal hydride storage can also be used for the storing of hydrogen gas at lower pressure. If needed, the hydrogen gas stored in the storage unit 164 can be drawn off and converted back into electrical DC current with the aid of the fuel cell, and fed back into the DC voltage busbar 150. In this case, the energy converter 162 preferably comprises at least one electrolysis cell, a fuel cell, and a DC-DC converter or a direct current converter.

When an excess of electrical energy arises on the DC busbar 150, the storage unit 164 integrated in the energy storage 160 can be charged with the suitable energy form after a corresponding conversion with the aid of the energy converter 162, which is symbolized by a white charging arrow 190. The storage unit 164 is preferably designed for the storing of electrical energy so that using the energy converter 162, an adapting of the DC energy is only needed with respect to voltage and/or current. If one of the electrical consumers 106, 108, 110 causes a load peak, energy is drawn from the storage unit 164, which is illustrated by a white discharge arrow 192. Due to the energy converter 162, the reconversion then occurs of the energy flowing out of the storage unit 164 into electrical DC voltage or direct current energy that is directly deliverable into the DC busbar 150. However, if there is an oversupply of DC voltage energy in the region of the DC busbar 150, then this energy can in turn be converted with the aid of the energy converter 162 into the energy form suitable for the storage unit 164 of the energy storage 160, and then stored.

For the case that the electrical system 142 is configured as a three-phase supply 144, the main energy converter 140 includes at least one rectifier 170. In the simplest case, the rectifier 170 can be realized in terms of circuit technology with a passive diode bridge, which, however allows only a unidirectional energy flow from electrical system 142 via the main energy converter 140 into the DC voltage busbar 150, which is illustrated with the simple arrows 172, 174, each with dotted lines. However, instead of the rectifier 170 constructed with a diode bridge, an active front end module 180 is preferably integrated in the main energy converter 140 in order to allow a bidirectional exchange of electrical energy between the three-phase supply 144 and the DC busbar 150 using the main energy converter 140.

Using the active front end module 180, the main energy converter 140 makes possible a bidirectional exchange of electrical energy between the three-phase supply 144 and the main energy converter 140 and the DC busbar 150. The active front end module 180 can be realized, for example, with actively switchable electronic switches, such as IGBT's, power bipolar transistors, or power MOSFETs. The detailed structure of the main energy converter 140 using the active front end module 180 is sufficiently familiar to a person skilled in the art active in the field of energy electronics that at this point for the sake of brevity of the description, a detailed explanation of the details in terms of circuit technology is omitted.

Alternatively the electrical system 142 of the watercraft can also be embodied as a direct current system 146, which is more often the case in particular in smaller watercraft such as motor boats, motor yachts, or sailing yachts. In such a configuration, the main energy converter 140 is built using a DC-DC converter 182 or a DC voltage converter.

Due to the central DC busbar 150 to which all components of the modular energy supply system 100 are connected and the resolved design and the common use of all components, first of all a more spatially compact structure of the energy supply system 100 is realizable. Due to the resolved, modular design, furthermore the use of an active front end module in a three-phase current system, or the use of a DC/DC converter or of a DC voltage converter in the case of a direct current system, is possible without problem. Due to the energy supply system 100, possible peak loads caused by consumers 106, 108, can be buffered, whereby an overloading of the electrical system 142 of the watercraft or of the ship is securely prevented. Furthermore, it is no longer necessary to design a peak load of an onboard generator of the watercraft for the supplying of the electrical system 142 based on any maximum loads caused by the consumers 106, 108 connected to the energy supply system 100.

The invention relates to an energy supply system 100 for a watercraft with a main energy converter 140 that is configured for connection to an electrical system 142 of the watercraft. According to invention, the main energy converter 140 is connected to a DC busbar 150, and at least one inverter 152, 154, 156 is connected to the DC busbar 150 for the supplying of a respective consumer associated with the inverter 152, 154, 156, and at least one electrical energy storage 160 is connected to the DC voltage busbar 150. Due to the common use of electrical components among other things a significant reduction of the installation space requirements of the energy supply system 100 is realizable for a watercraft.

### REFERENCE NUMBER LIST

100 Energy supply system
106 Electrical consumer
108 Electrical consumer
110 Electrical consumer
120 Stabilizing device
122 Stabilizing device
124 Electrical drive unit
126 Electrical drive unit
128 Stabilizing fin
130 Stabilizing fin
132 Steering system
134 Electrical drive unit
136 Rudder blade
140 Main energy converter
142 Electrical system (watercraft)
144 Three-phase supply
146 Direct current supply
150 DC busbar
152 Inverter
154 Inverter
156 Inverter
160 Energy storage
162 Energy converter
164 Storage unit
170 Rectifier
172 Arrow
174 Arrow
180 Active front end module
182 DC-DC converter
190 Charging arrow
192 Discharging arrow

1. An energy supply system for a watercraft, the watercraft having an electrical system, the energy supply system comprising:
a DC busbar,
a main energy converter configured for connection to the electrical system of the watercraft, the main energy converter being connected to the DC busbar,
at least one inverter connected to the DC busbar and configured to supply at least one consumer associated with the inverter, and
at least one electrical energy storage connected to the DC busbar,
wherein the at least one consumer is a stabilizing device of the watercraft or a steering system of the watercraft.

2. (canceled)

3. The energy supply system according to claim 1, wherein the electrical system of the watercraft is a three-phase current system.

4. The energy supply system according to claim 3, wherein the main energy converter includes at least one rectifier.

5. The energy supply system according to claim 4, wherein the main energy converter includes at least one active front end module.

6. The energy supply system according to claim 1, wherein the electrical system of the watercraft is a direct current system.

7. The energy supply system according to claim 6, wherein the main energy converter includes at least one DC-DC converter.

8. The energy supply system according to claim 1, wherein the energy storage includes at least one energy converter for connection to the DC busbar and at least one storage unit.
